(19) United States
(12) Patent Application Publication
(10) Pub. No.: US 2025/0272028 A1
(43) Pub. Date: Aug. 28, 2025

(54) STORAGE CAPACITY EXPANSION USING VOLUME ADDITION FOR CLOUD COMPUTING CLUSTERS

(71) Applicant: Dell Products L.P., Round Rock, TX (US)

(72) Inventors: Steven Soumpholphakdy, Chicago, IL (US); Daniel Ryan, Minneapolis, MN (US); Raymond Ramsden, Seattle, WA (US); Joshua Nelson, Gig Harbor, WA (US)

(21) Appl. No.: 18/588,574

(22) Filed: Feb. 27, 2024

(51) Int. Cl. G06F 3/06

(52) U.S. Cl. CPC G06F 3/0665; G06F 3/0604; G06F 3/0631; G06F 3/067

(57) ABSTRACT

A method facilitating storage capacity expansion using volume addition for cloud computing clusters includes suspending, by a system including at least one processor, changes to an infrastructure configuration of a group of virtual machines (VMs) of a cloud computing system in response to receiving a request to expand a storage capacity of the group of VMs; associating, by the system in response to the suspending, new storage volumes with respective VMs of the group of VMs; and resuming, by the system, the changes to the infrastructure configuration of the group of VMs in response to the associating being determined to have successfully completed.

### BACKGROUND

In a cloud computing deployment that utilizes a clustered file system, computing clusters can be formed of similarly configured physical or virtual computing machines, and each machine in a given cluster can have one or more (real or virtual) attached storage drives or volumes. Additionally, respective machines and/or their attached drives can be interconnected via backend networking to enable communication between respective devices of the cluster. In such an implementation, it is desirable to facilitate techniques for expanding the storage capacity of a cloud computing cluster in an efficient manner.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a configuration component that freezes a topology configuration of a cluster of virtual machines (VMs) operating in a cloud computing system in response to a storage expansion request for the cluster of VMs. The executable components can further include a storage expansion component that adds new storage volumes to respective VMs of the cluster of VMs in response to the configuration component freezing the topology configuration of the cluster of VMs, and the configuration component can facilitate updating the topology configuration of the cluster of VMs in response to the storage expansion component successfully adding the new storage volumes.

In another implementation, a method is described herein. The method can include suspending, by a system including at least one processor, changes to an infrastructure configuration of a group of VMs of a cloud computing system in response to receiving a request to expand a storage capacity of the group of VMs. The method can further include associating, by the system in response to the suspending, new storage volumes with respective VMs of the group of VMs. The method can also include resuming, by the system, the changes to the infrastructure configuration of the group of VMs in response to the associating being determined to have successfully completed.

In an additional implementation, a non-transitory machine-readable medium is described herein that can include instructions that, when executed by a processor, facilitate performance of operations. The operations can include freezing a topology configuration of virtual devices in a cloud computing cluster in response to receiving a request for additional storage capacity for the cloud computing cluster; adding, in response to the freezing, storage volumes to respective ones of the virtual devices; and unfreezing the topology configuration of the virtual devices in response to the storage volumes being determined to have been successfully added to the respective ones of the virtual devices.

### DESCRIPTION OF DRAWINGS

Various non-limiting embodiments of the subject disclosure are described with reference to the following figures, wherein like reference numerals refer to like parts throughout unless otherwise specified.

FIGS. 1-4 are block diagrams of respective systems that facilitate storage capacity expansion using volume addition for cloud computing clusters in accordance with various implementations described herein.

FIGS. 5-6 are diagrams illustrating an example workflow that facilitates storage capacity expansion for a computing cluster in the cloud in accordance with various implementations described herein.

FIGS. 7-10 are messaging flow diagrams depicting respective executable routines of a process to facilitate storage capacity expansion using volume addition for cloud computing clusters in accordance with various implementations described herein.

FIG. 11 is a flow diagram of a method that facilitates storage capacity expansion using volume addition for cloud computing clusters in accordance with various implementations described herein.

FIG. 12 is a flow diagram depicting respective operations facilitating storage capacity expansion using volume addition for cloud computing clusters that can performed by a processor in accordance with various implementations described herein.

FIG. 13 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

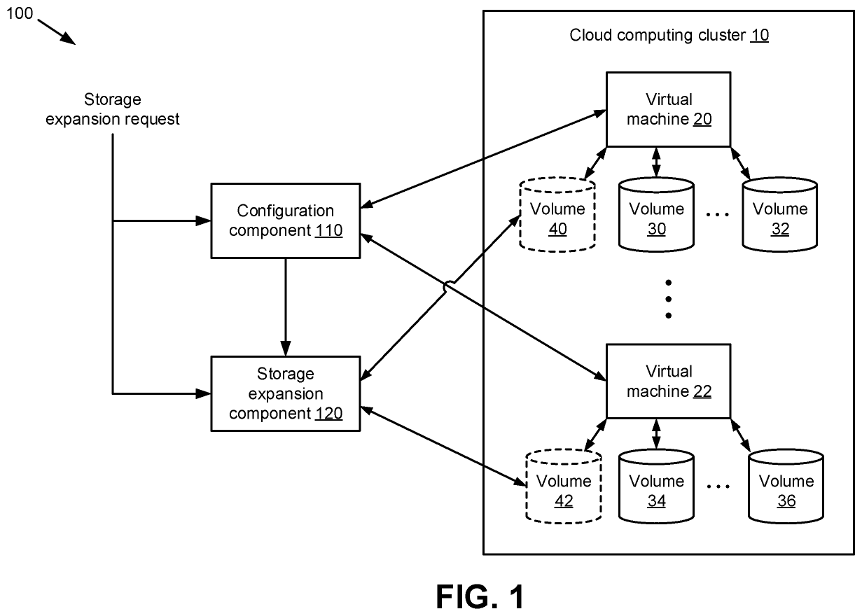

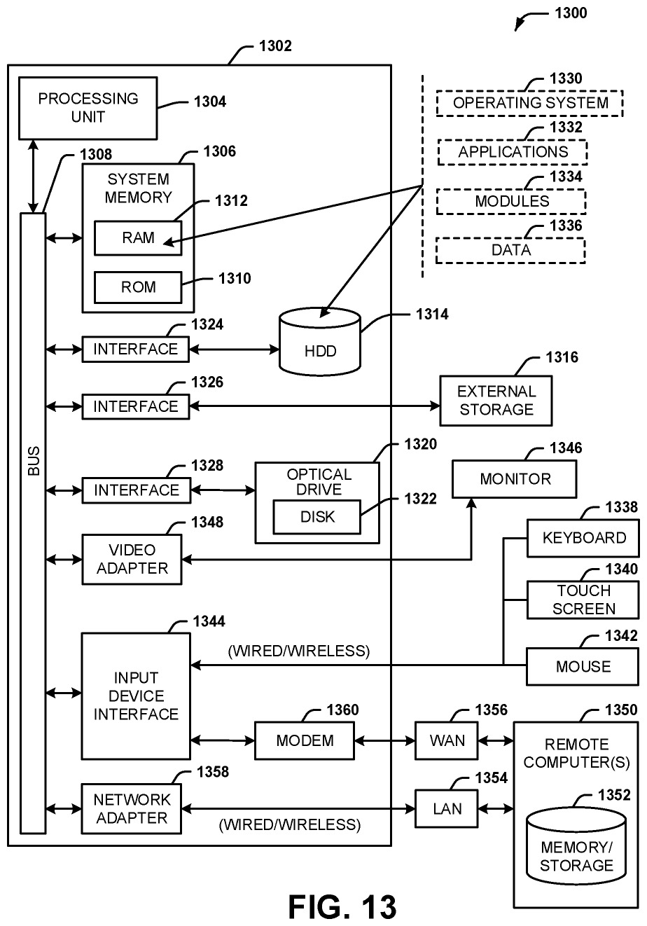

With reference now to the drawings, FIG. 1 illustrates a block diagram of a system 100 that facilitates storage capacity expansion using volume addition for cloud computing clusters, e.g., a cloud computing cluster 10, in accordance with various implementations described herein. System 100 as shown in FIG. 1 includes a configuration component 110 and a storage expansion component 120, each of which can operate as described in further detail below. In an implementation, the components 110, 120 of system 100 can be implemented in hardware, software, or a combination of hardware and software. By way of example, the components 110, 120 can be implemented as computer-executable components, e.g., components stored on a memory and executed by a processor. Examples of computer architectures including a processor and a memory that can be used to implement the components 110, 120 as well as other components as will be described herein, are shown and described in further detail below with respect to FIG. 13.

Additionally, it is noted that the functionality of the respective components shown and described herein can be implemented via a single computing device and/or a combination of devices. For instance, in various implementations, the configuration component 110 shown in FIG. 1 could be implemented via a first device, and the storage expansion component 120 could be implemented via the first device or a second device. Also, or alternatively, the functionality of a single component could be divided among multiple devices in some implementations.

As shown in FIG. 1, the components 110, 120 can be utilized to manage respective elements of a cloud computing cluster 10, which can include one or more virtual machines (VMs) 20, 22 and respective volumes 30, 32, 34, 36 associated with the VMs 20, 22. In an implementation as shown in FIG. 1, the cloud computing cluster 10 can be associated with a cloud computing system that utilizes a distributed clustered file system, in which one or more volumes 30, 32, 34, 36 used for file system storage are attached to respective ones of the VMs 20, 22, which provide computing functionality for the cloud computing system. Respective VMs 20, 22 associated with the cloud computing cluster 10 can be similarly configured, e.g., in terms of processing power, memory amount, number of attached volumes, and/or other criteria. Additionally, VMs 20, 22 associated with a given cluster, such as the cloud computing cluster 10 shown in FIG. 1, can be interconnected through backend networking, enabling the VMs 20, 22 to communicate with each other. While only two VMs 20, 22 are illustrated as part of the cloud computing cluster 10 in FIG. 1 for simplicity of illustration, it is noted that the cloud computing cluster 10 could include any suitable number of VMs 20, 22, each of which can be associated with one or more volumes 30, 32, 34, 36.

In some implementations, the cloud computing cluster 10 can be supported by a set of node devices, also referred to herein as a nodepool. As used herein, a nodepool refers to a logical grouping of storage nodes within a cluster (e.g., cloud computing cluster 10), where a “storage node” can include one or more storage volumes 30, 32, 34, 36, as well as VM(s) 20, 22 with which those volumes 30, 32, 34, 36 are associated. In some implementations, a nodepool can facilitate management and organization of storage resources within a cluster, e.g., a group/set of associated nodes within the cluster that have the same configuration, such as groups of disk pools spread across similar, or compatible, storage nodes.

While various examples provided herein relate to a cluster configuration having one nodepool, it is noted that a given cluster, such as the cloud computing cluster 10 shown in FIG. 1, could include more than one nodepool. In general, a nodepool can group nodes that are similar in terms of VM types (e.g., similar CPU, RAM, networking, etc.), volume types (e.g., HDD, SSD, etc.), volume capacity, volume count, and/or other properties. Accordingly, if a cluster includes nodes that are split among two or more different configuration types, the cluster could have multiple nodepools as opposed to one.

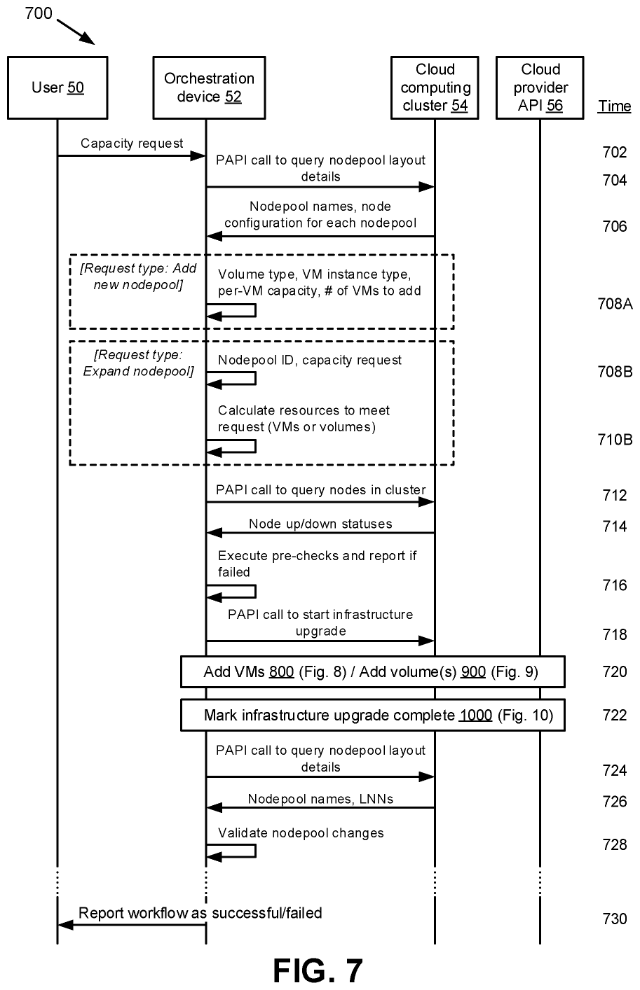

In an implementation, one or more of the components 110, 120 of system 100 can be implemented via an orchestration engine that resides outside of the cloud computing cluster 10 and assists in driving any orchestration associated with the cloud computing cluster 10. Orchestration tasks that can be performed by the orchestration engine can include, for example, lifecycle management, self-healing, and/or any other actions that are desirably taken on the cloud computing cluster 10, e.g., via a platform application programming interface (Platform API or PAPI), and/or a cloud provider associated with the cloud computing cluster 10, e.g., via Cloud APIs. As used herein, e.g., with respect to FIGS. 7-10 below, a computing device on which the orchestration engine and/or any components thereof can reside is referred to as an “orchestration device.” Accordingly, system 100 can be composed of one or more orchestration devices, each of which can implement one or more of the components 110, 120, and/or other suitable components as will be described in further detail below.

In implementations, the volumes 30, 32, 34, 36 of the cloud computing cluster 10 as shown in FIG. 1 can be physical storage devices (e.g., drives) or virtual storage devices that are composed of one or more physical storage devices. In an implementation in which the volumes 30, 32, 34, 36 are virtual devices, a given volume 30, 32, 34, 36 as shown in FIG. 1 can be composed of one or more physical drives, or portions (stripes, sectors, partitions, etc.) of one or more physical drives, that are operated by the cloud computing cluster 10 as a single storage device. Thus, from the perspective of system 100, each of the volumes 30, 32, 34, 36 of the cloud computing cluster 10 can be managed as though they are different physical storage devices, such as Peripheral Component Interconnect (PCI) devices or the like. For this reason, the terms “volume” and “drive” (referring to a logical drive, unless stated otherwise) are used in this description interchangeably. In addition, various implementations described herein can facilitate the addition of new storage volumes 40, 42 to the cloud computing cluster 10 as will be described in further detail below, and these volumes 40, 42 can be configured in a similar manner to the volumes 30, 32, 34, 36 of the cloud computing cluster 10 as described above.

While FIG. 1 illustrates direct communication between elements of system 100 and devices of the cloud computing cluster 10, it is noted that, in some implementations, system 100 can communicate with a cloud provider or other entity associated with the cloud computing cluster 10 instead of individual volumes or other devices of the cloud computing cluster 10. This can be done, for example, to provide abstraction for the physical composition of the cloud computing cluster 10 and simplify operation of system 100 and/or other computing devices that interact with the cloud computing cluster 10. By way of example, while each volume 30, 32, 34, 36 in the cloud computing cluster 10 may be composed of multiple physical devices that are each attached to respective VMs 20, 22 as described above, the cloud computing cluster 10 can nonetheless represent each volume 30, 32, 34, 36 as a single device in order to enable system 100 to run a file system and/or associated applications on the cloud volumes 30, 32, 34, 36 irrespective of the physical configurations of those volumes 30, 32, 34, 36.

As part of supporting services in the cloud, system 100 can provide clients or end users with the ability to add capacity to a deployed cluster, e.g., the cloud computing cluster 10 shown in FIG. 1. In some implementations, capacity can be added to a cloud deployment via VM addition. As described herein, system 100 can facilitate techniques to add capacity in a more granular way via incorporating the ability to grow by volume addition in combination with, or in place of, VM addition.

Various implementations herein can provide highly granular capacity expansion for cloud deployments, such as deployments associated with architecture constraints in which all volumes and/or VMs of a given cluster are configured in a similar or identical manner. By way of specific, non-limiting example, a cloud computing cluster could have four nodes, where each node manages 25 4 terabyte (TB) drives for a total per-node storage capacity of 100 TB. In addition to expanding the capacity of the system by adding new 100 TB nodes, various implementations described herein can also facilitate adding additional drives to the cluster nodes, which enables storage to be added to the cluster in increments of 16 TB, or one 4 TB drive for each of the four existing nodes. Adding a similar new drive to each cluster node can be done, for example, to satisfy architecture constraints in which (1) volume(s) being added are to match the volume size, type, and/or performance characteristics of those already in the nodepool, and (2) volume addition is to be done for all VMs in the nodepool being expanded.

Various techniques for volume addition as described herein can be used to supplement capacity expansion methods provided by cloud provider APIs, which generally lack the granularity provided in the implementations described herein. For example, using existing cloud-based methods to add a volume to a VM can result in the capacity simply being attached to the VM without coordinating any steps to ensure that the volume is added to the underlying file system, and this can leave the cluster in an undesirable state. To expand on this, if volumes are simply added to each node in a given nodepool, existing cloud-based approaches could create a new nodepool once the volume count of any of the VMs in the nodepool changes. Such a case can result in a new nodepool and an orphaned node (e.g., the nodepool prior to the upgrade). As each node changes, a new nodepool would be created, and those new nodepools would not retain any of the policies or settings applied to the previous nodepool. Moreover, all of the drives in the new nodepool would need to be reprovisioned, which is inefficient.

In view of at least the foregoing, various implementations described herein can enhance the orchestration workflows that grow the capacity of a cloud-based cluster by providing additional workflows for coordinating volume addition.

By enabling cluster growth via volume addition in place of, or in combination with, VM addition, the implementations described herein can provide several advantages that can improve the performance of a computing system, e.g., a computing system that includes one or more cloud computing clusters 10 that utilize services provided via a cloud computing system. These advantages can include, but are not limited to, the following. System storage capacity can be added in smaller and more granular amounts than those associated with addition of a VM, which can increase the efficiency, cost effectiveness, and/or other properties of a cloud deployment. Storage capacity can be added to respective VMs of a cloud computing cluster in a manner that enables operations such as reprovisioning or rebalancing a single time at the conclusion of all additions, which can increase system and volume uptime as well as enable computing resources such as processor cycles, network bandwidth, etc., that would be expended performing reprovisioning operations multiple times, e.g., once for each new volume, to instead be used for serving client load. Other advantages are also possible.

With respect now to the components 110, 120 of system 100 shown in FIG. 1, the configuration component 110 can freeze a topology configuration of a cluster of VMs operating in a cloud computing system, e.g., the cloud computing cluster 10 and its VMs 20, 22 as shown in FIG. 1, in response to a storage expansion request being received for the cluster, e.g., from a user or client device or other requesting entity or system. In an implementation, the configuration component 110 can freeze the topology configuration of the cluster by indicating to the cloud computing cluster 10, e.g., via a PAPI associated with the cloud computing cluster 10, that system 100 is starting an infrastructure upgrade. This indication can be utilized to inform the cloud computing cluster 10 that it is not to react to the new infrastructure (e.g., volumes 40/42, new VMs, new nodepools, etc.) being added. This can be accomplished by, e.g., freezing the drive purpose database along with nodepool compatibility changes to ensure that a new nodepool is not created during the infrastructure upgrade process.

To state the above another way, the configuration component 110 can facilitate addition of volumes by adding functionality to node compatibility to ensure that the cloud computing cluster 10 does not react to changes in node topology as system 100 cycles through adding volumes 40, 42 to each node in the nodepool. As noted above, this functionality can be controlled via the configuration component 110 indicating that system 100 is starting an upgrade.

By preventing changes in node topology, system 100 can ensure that as volumes 40, 42 are added to each node, unbalanced diskpools are not created and the amount of work to alter the layout of stored data at the cloud computing cluster 10 is limited. As will be described in further detail below, this can facilitate delaying the infrastructure upgrade until all new volumes are added, which can ensure that a uniform upgrade occurs across each node in the nodepool and that the nodes remain compatible. Delaying the infrastructure upgrade can also insure that all diskpool changes are uniform across the nodepool. By doing so, system 100 can ensure that no volumes are left unprovisioned and that the process is optimized for efficiency and to reduce the overall work necessary following the provisioning changes.

In response to the configuration component 110 freezing the topology configuration of the cloud computing cluster 10 as described above, the storage expansion component 120 shown in FIG. 1 can add new storage volumes 40, 42 to respective VMs 20, 22 of the cloud computing cluster 10. In implementations, once the configuration component 110 has marked system 100 ready for an infrastructure upgrade, the storage expansion component 120 can start adding volumes 40, 42 to each of the nodes in the nodepool designated for expansion with the knowledge that the cloud computing cluster 10 will not react to the changes until all volumes 40, 42 have been added. As the storage expansion component 120 cycles through each of the VMs 20, 22, it can make the appropriate cloud provider API call to create a new volume and attach it to the appropriate VM.

In an implementation, volume(s) 40, 42 created by the storage expansion component 120 can match the volume size, type, and performance characteristics of the other volumes in the target nodepool. For instance, each of the volumes 30, 32, 34, 36 that are associated with the VMs 20, 22 prior to addition of new volumes can be configured with a common storage capacity, and the new volumes 40, 42 added by the storage expansion component 120 as described above can also be configured with the same common storage capacity. Moreover, to facilitate consistent operation between VMs 20, 22 and/or for other purposes, the storage expansion component 120 can also add an equal number of new storage volumes 40, 42 to each VM 20, 22 in the cloud computing cluster 10. While FIG. 1 shows an example in which only one new volume 40, 42 is added to respective VMs 20, 22, it is noted that similar operations to those described herein could be performed by the storage expansion component 120 to add any suitable number of volumes to the respective VMs 20, 22, provided that the number of volumes added is consistent for each of the VMs 20, 22.

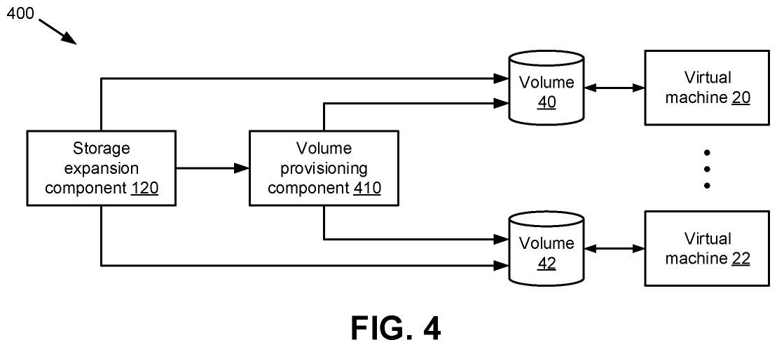

In response to the storage expansion component 120 successfully adding new storage volumes 40, 42 to the cloud computing cluster 10 as described above, the configuration component can facilitate unfreezing and updating the topology configuration of the cloud computing cluster 10. For instance, once the capacity upgrade is complete, the configuration component 110 can activate the infrastructure upgrade, based on which the cloud computing cluster 10 can determine that the drive purpose database has changed. In response, the cloud computing cluster 10 can take the newly added and unprovisioned drives, reform the diskpools appropriately, and update any metadata tied to the nodepool (e.g., new capacity). Operations that can be performed in connection with provisioning new volumes and making the new volumes available for use are described in further detail below with respect to FIG. 4. By marking the infrastructure upgrade as complete upon the conclusion of adding new volumes, the cloud computing cluster 10 can process all changes to the topology of the cluster at one time, thereby avoiding inefficiency associated with processing intermediate states as described above.

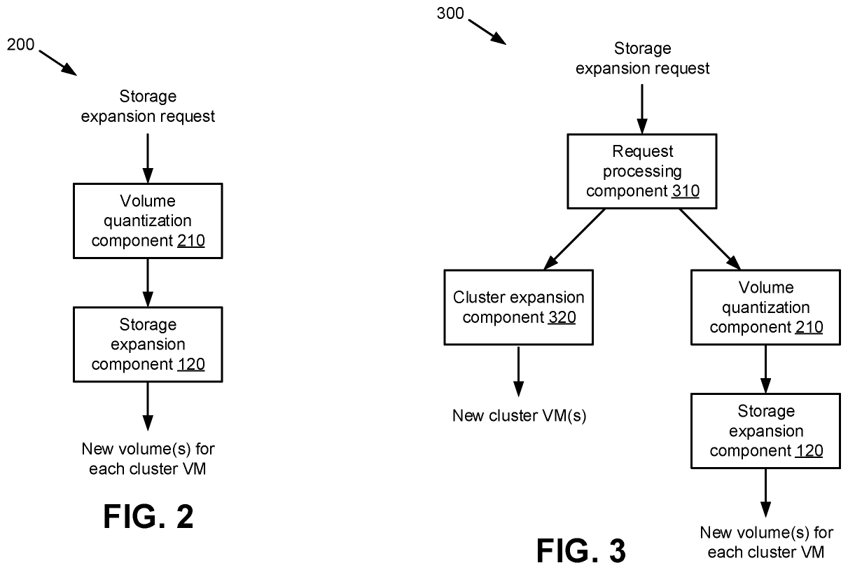

With reference next to FIG. 2, a block diagram of another system 200 that facilitates storage capacity expansion using volume addition for cloud computing clusters is illustrated. Repetitive description of like parts described above with regard to other implementations is omitted for brevity. System 200 includes a volume quantization component 210 that can determine an amount of new storage volumes, e.g., the new volumes 40, 42 shown in FIG. 1, to be added by the storage expansion component 120 based on information provided in a storage expansion request provided to system 200. In implementations, the volume quantization component can determine the amount of new volumes to add as a function of a total amount of storage capacity specified in the storage expansion request, a common capacity of the volumes present in an associated cluster (e.g., the cloud computing cluster 10 shown in FIG. 1), and an amount of VMs (e.g., VMs 20, 22 as shown in FIG. 1) present in the associated cluster.

In an implementation, the volume quantization component 210 can calculate the number of volumes to be added for respective nodes in the target nodepool by dividing the total amount of capacity specified in the capacity request, dividing that capacity by the number of nodes in the nodepool, and then dividing the resulting value by the per-drive capacity within the nodepool to determine the number of volumes to be added per node. As a result, system 200 can facilitate more granular storage capacity addition than can be achieved through addition of VMs. For instance, system 200 can facilitate the addition of storage capacity to a given nodepool in units as small as the number of VMs in the target nodepool multiplied by the per-drive capacity for the VMs in the nodepool. As a specific, non-limiting example for a four-node cluster where each node in the cluster belongs to a common nodepool and has 25 volumes of 4 TB each for a total per-node storage of 100 TB, the smallest unit that can be added via system 200 is equal to (4 nodes)*(4 TB per drive)=16 TB.

In the event that a given cluster contains multiple nodepools, e.g., due to the cluster having groups of nodes that are configured differently from each other, system 200 can also facilitate the addition of volumes to target nodepools within the cluster and/or other subsets of VMs or other nodes within a given cluster. For example, the volume quantization component 210 could determine a number of volumes to add to respective nodes of a first nodepool of a cluster while determining a different number of volumes to add to a second, different nodepool of the cluster. In some cases, the volume quantization component could facilitate adding volumes to only some nodepools of a cluster, e.g., such that the number of new volumes added to nodes of the second nodepool in the previous example is zero.

Turning now to FIG. 3, another system 300 that facilitates storage capacity expansion using volume addition for cloud computing clusters is illustrated. System 300 as shown in FIG. 3 includes a request processing component that can forward a received storage expansion request to an appropriate component of system 300 for further processing, e.g., the volume quantization component 210 described above with respect to FIG. 2 and/or a cluster expansion component 320 that will be described in further detail below, based on an amount of capacity specified in the request.

In an implementation, the request processing component 310 can compare a first amount of storage capacity specified in an incoming request to a second amount of storage capacity that is managed by a VM in a target nodepool, e.g., a VM 20, 22 in a cloud computing cluster 10 as described above with respect to FIG. 1. If the first amount of storage capacity provided in the request is less than the second amount of storage capacity that is managed by the respective nodepool VMs, the request processing component 310 can provide the request to the volume quantization component 210, e.g., to facilitate addition of new storage volumes via the volume quantization component 210 and the storage expansion component 120 in the manner described above with respect to FIG. 2.

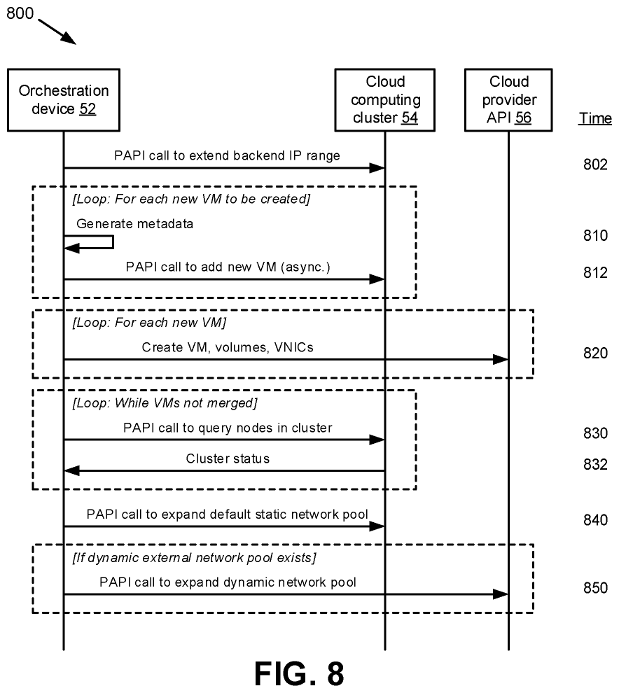

Alternatively, if the amount of additional storage requested is greater than the amount of storage capacity managed by the respective nodepool VMs, the request processing component 310 can instead provide the request to the cluster expansion component 320, which can facilitating adding one or more new VMs to the nodepool and/or a cluster associated with the nodepool. A process flow that can be utilized by the cluster expansion component 320 to add new VMs is described in further detail below with respect to FIG. 8.

In some implementations, the request processing component 310 could also facilitate the addition of both VMs and new volumes to a given cluster in response to a storage expansion request. For instance, if an amount of requested additional storage capacity is sufficiently greater than the amount of storage managed by each VM in the cluster, the request processing component 310 could facilitate addition of one or more VMs via the cluster expansion component 320 as well as addition of one or more volumes for each VM via the volume quantization component 210 and storage expansion component 120. In such a case, the request processing component 310 could split the request between VM addition and volume addition as a function of the total amount of storage capacity that will be managed by each VM after all new volumes are added, e.g., instead of the amount of storage capacity managed by each VM prior to the addition of new volumes, to ensure that all VMs of the cluster will be associated with the same amount of storage capacity after all additions are completed.

In some implementations, the request processing component 310 could also determine whether to fulfill a storage expansion request via additional VMs or volumes based on cluster performance considerations. For instance, in the event that the request processing component 310 determines that additional volumes cannot be added to the VMs of a given cluster without adversely impacting the performance of the cluster beyond an acceptable degree, the request processing component 310 could instruct the cluster expansion component 320 to add an additional VM to the cluster even if the total amount of requested capacity is smaller than the amount of storage managed by each VM in the cluster.

Referring next to FIG. 4, a block diagram of an additional system 400 that facilitates storage capacity expansion using volume addition for cloud computing clusters is illustrated. Repetitive description of like parts described above with regard to other implementations is omitted for brevity. System 400 as shown in FIG. 4 includes a storage expansion component 120 that can add new storage volumes 40, 42 to respective VMs 20, 22 associated with a nodepool or cluster, e.g., the cloud computing cluster 10 shown in FIG. 1, as generally described above. System 400 further includes a volume provisioning component 410 that can facilitate provisioning the new volumes 40, 42 and enabling their use via the VMs 20, 22. By way of example, the volume provisioning component 410 can assign respective ones of the new storage volumes 40, 42 to volume failure domains (e.g., diskpools) associated with an underlying computing cluster in response to the topology configuration of the cluster being resumed (e.g., by the configuration component 110 as described above with respect to FIG. 1.).

In implementations, the volume provisioning component 410 can make the new volumes 40, 42 available to the respective VMs 20, 22 in response to the volumes 40, 42 being added via the storage expansion component 120. By way of example, once the volumes 40, 42 have been attached, the volume provisioning component 410 can leverage PCI hotplug capabilities to enable discovery of the volumes and activate a drive state daemon for further processing. The drive state daemon can assign the volumes 40, 42 bay numbers and then inspect their contents. Because the volumes 40, 42 will appear blank on first inspection, the volume provisioning component 410 can additional format the volumes 40, 42 for file system usage. Once formatted, the volumes 40, 42 are ready to be mounted. At this point, the volume provisioning component 410 can store the drive details to a data store, e.g., a drive database or the like, and assign the volumes 40, 42 logical drive numbers. Once mounted, the volumes 40, 42 can be given a purpose, and the capacity associated with the volumes 40, 42 can be made available to the VMs 20, 22.

In addition, the volume provisioning component 410 can facilitate completing the capacity expansion by activating the infrastructure upgrade that was initiated by the configuration component 110 as described above with respect to FIG. 1. Activating the upgrade can include unfreezing the drive purpose database and then reprovisioning. To facilitate reprovisioning, the volume provisioning component 410 can look at the drive purpose database, take the unprovisioned and newly added volumes 40, 42, and reform the diskpools.

When reforming the diskpools, the volume provisioning component 410 can balance the diskpools to optimize performance. For instance, if a system has an initial storage unit size of 6 and starts with 12 volumes and then another 6 volumes are added, the upgrade can result in three diskpools of 6 volumes. In the same example, if one additional volume is added instead of six volumes, the diskpools can instead be reconfigured to include 4, 4, and 5 volumes, respectively. This can be done, e.g., to ensure that the diskpools are optimized for performance and that rebalancing remains efficient.

Once the diskpools have been formed, the volume provisioning component 410 can update the nodepool to reflect the infrastructure upgrade. Next, the volume provisioning component 410 can reinitialize platform configuration storage to ensure that clients have the most up-to-date configuration data post-upgrade. Lastly, the volume provisioning component 410 can validate that the nodepool was expanded to the desired capacity. In implementations, the volume provisioning component 410 can utilize validation logic for VM addition for this purpose.

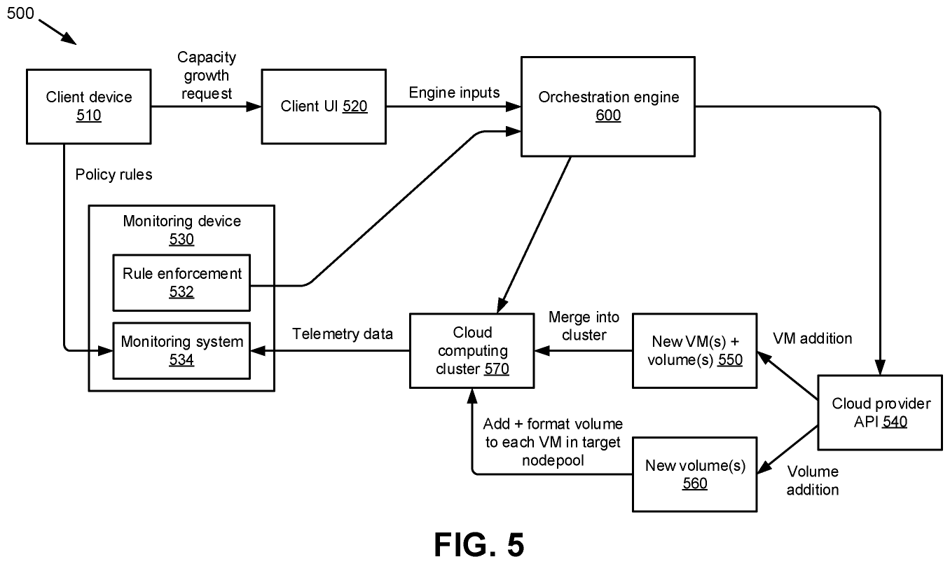

With reference now to FIG. 5, an architecture diagram of an example system 500 that can facilitate increasing storage capacity of a storage cluster is illustrated. System 500 as shown in FIG. 5 includes a client device 510, client user interface (UI) 520, a monitoring device 530 that includes a rule enforcement engine 532 and a monitoring system 534, a cloud provider API 540, and a cloud computing cluster 570 that can provide telemetry data to the monitoring system 534. As further shown in FIG. 5, the monitoring system 534 can receive policy rules from the client device 510.

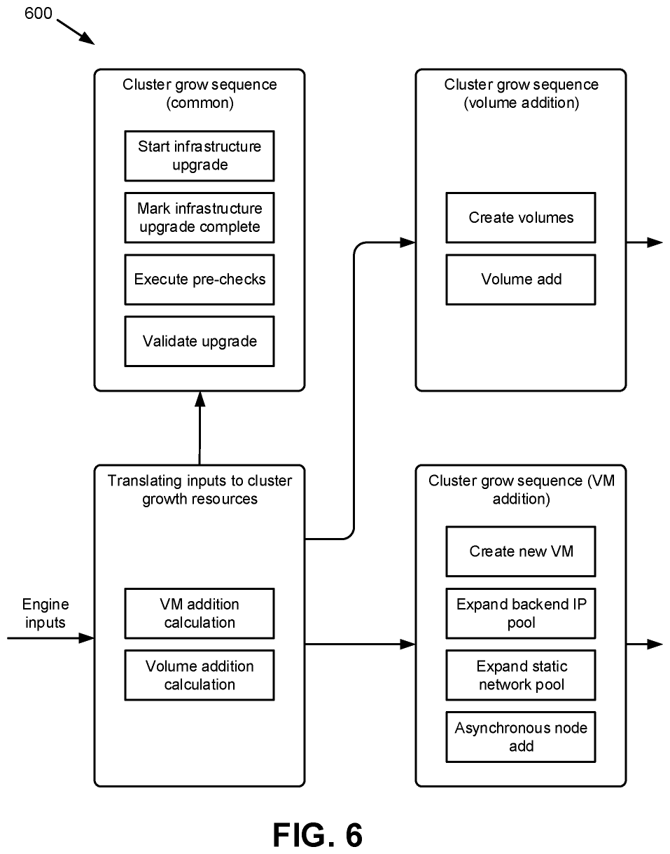

In a first approach to causing an expansion of the storage capacity of the cluster 570, the client UI 520 can receive a capacity growth request via the client device 510 and communicate related engine inputs to an orchestration engine 600, which is shown in further detail in FIG. 6. The orchestration engine 600 can receive engine inputs based on the growth request and translate those inputs into a capacity specification for resources to be used to grow the storage capacity of the cluster 570 by a selected amount. Alternatively, a growth request can include a request to expand an existing cluster by a selected amount. In one or more implementations, the growth request can be a direct request from the client device 510 that is not based on monitoring of the cluster 570. As such, the engine inputs can represent a client-requested approach to expanding capacity.

Also or alternatively, instead of a specific request from the client device 510 causing a change in capacity, engine inputs can be generated by the rule enforcement engine 532 based on monitoring of the operation of the cluster 570 by the monitoring system 534. In this approach, policy rules can be generated based on input from the client device 510, e.g., a maximum number of nodes that can be deployed to support the cluster, a minimum and/or maximum available storage capacity of the cluster 570, a maximum number of volumes that can be attached to a given node of the cluster 570, and/or other capacity characteristics of the cluster 570.

Continuing this example, the cluster 570 can capture and provide telemetry to the monitoring system 534, where policy rules can be used as criteria for evaluating the telemetry. In implementations, the monitoring system 534 can check received telemetry data against policy rules, and, if rules are implicated, communicate the relevant rules to the rule enforcement engine 532. Based on processing performed by the rule enforcement engine 532, engine inputs can be generated and provided to the orchestration engine 600 for modification of the storage capacity of the cluster 570.

Turning now to FIG. 6, and with further reference to FIG. 5, the orchestration engine 600 can receive engine inputs as provided by the client UI 520 and/or the rule enforcement engine 532 as described above. As shown in FIG. 6, the orchestration engine 600 can translate the engine inputs into a capacity specification that identifies resources for growing the cluster 570 in accordance with associated policy rules. As shown in FIG. 6, this process of input translation can include calculating a number of new VMs and/or volumes to add to the cluster 570, e.g., based on one or more criteria such as those described above with respect to FIG. 3. For both the case of volume and VM addition, the orchestration engine 600 can initiate common stages of a cluster grow sequence, including starting an infrastructure upgrade prior to addition and marking the infrastructure upgrade as complete upon completion of the addition.

As further shown in FIG. 6, the orchestration engine 600 can tailor the cluster grow sequence for volume addition and/or VM addition based on the capacity specification and the manner in which the engine inputs were translated to further action as described above. Returning now to FIG. 5, the orchestration engine 600 can provide instructions to carry out the appropriate cluster growth operation(s) to a cloud provider API 540 associated with the cluster 570. In the event that VM addition is initiated by the orchestration engine 600, the instructions provided to the cloud provider API 540 can facilitate the configuration and deployment of a target VM 550 to support the cluster 570 and achieve the requested change in storage capacity. The target VM 550 can then be merged into the set of node devices of the cluster 570, e.g., a nodepool associated with the cluster 570, based on instructions from the cloud provider API 540.

Also or alternatively, in the event that volume addition is initiated by the orchestration engine 600, the instructions provided to the cloud provider API 540 can facilitate the creation and initialization of new volumes 560 for each VM in the nodepool associated with the cluster 570. For instance, the target volumes 560 can be added to each VM in the target nodepool and formatted for use in a file system associated with the nodepool based on instructions from the cloud provider API 540.

Referring next to FIGS. 7-10, a messaging flow diagram illustrating respective stages of a process 700 to facilitate storage capacity expansion using volume addition for cloud computing clusters is provided. In particular, FIGS. 7-10 show operations that can be performed by respective elements of a cloud computing infrastructure, including a user device 50, an orchestration device 52 (e.g., on which system 100 and/or other systems as described herein could be implemented), a cloud computing cluster 54 (e.g., a cloud computing cluster 10) that includes VMs and/or other real or virtual devices on which a cloud service is implemented, and a cloud provider API 56 that provides access to the cloud service. While various operations shown in FIGS. 7-10 are described relative to points in time, it is noted that the process 700 described herein is not necessarily limited by the relative timing of operations shown in FIGS. 7-10, as depending on implementation some operations could occur simultaneously and/or in a different order than what is illustrated.

Process 700 as shown in FIG. 7 begins at time 702, in which a capacity request is provided by the user device 50 to the orchestration device 52. At time 704, the orchestration device 52 can submit a PAPI call to the cloud computing cluster 54 to query the nodepool layout details of the cluster, and at time 706 the cloud computing cluster can respond to the query with the names, configurations, and/or other details of each associated nodepool.

Subsequent to time 706, process 700 can branch depending on whether the request submitted at time 702 is for addition of a new nodepool or expansion of an existing nodepool. If the request is for a new nodepool, the orchestration device 52 can determine at time 708A properties of the nodepool to be added, such as a volume type, VM instance type, per-VM capacity, a number of VMs to add, and/or other properties. If, instead, the request is to expand an existing nodepool, process 700 can instead proceed as shown at time 708B, in which the orchestration device 52 determines the target nodepool ID from the capacity request, and at time 710B, in which the orchestration device 52 calculates the resources (e.g., in terms of new VMs or volumes) to meet the request. For the purposes of this description, the remainder of process 700 as shown in FIGS. 7-10 assumes that the request is for expansion of an existing nodepool and proceeds from time 710B accordingly.

Next, at time 712, the orchestration device 52 submits a PAPI call to query the nodes in the cloud computing cluster 54, and the cluster 54 responds to this query at time 714 with the up/down statuses of each node in the cluster 54. At time 716, the orchestration device 52 can execute pre-checks associated with the requested capacity addition. If the pre-checks fail, process 700 can terminate (e.g., by proceeding directly to time 730 as will be described below and reporting the workflow as failed to the user device 50).

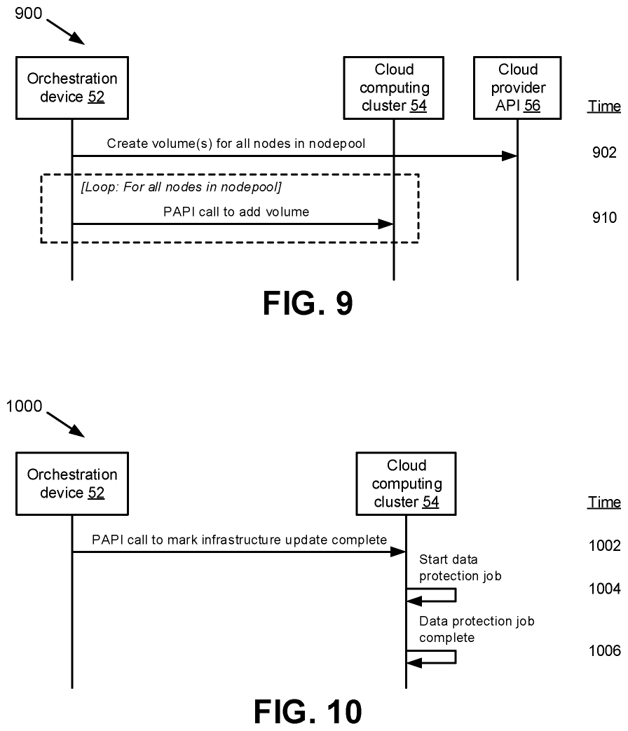

Upon successful completion of pre-checks at time 716, the orchestration device 52 can submit another PAPI call to the cloud computing cluster 54 to start an infrastructure upgrade at time 718. With an infrastructure upgrade started at the cluster 54, the orchestration device 52 can facilitate the requested capacity addition at time 720 through a VM addition procedure 800 as described below with respect to FIG. 8 and/or a volume addition procedure 900 as described below with respect to FIG. 9. Following the capacity addition at time 720, the orchestration device 52 can further facilitate marking the infrastructure upgrade initiated at time 718 as complete at time 722 via procedure 1000 as described below with respect to FIG. 10.

Upon successful completion of the infrastructure upgrade, the orchestration device 52 can submit a PAPI call to the cluster 54 at time 724 to query details of the nodepool layout of the cluster 54 resulting from the upgrade. The cluster 54 can respond to this query at time 726 with nodepool names, logical node numbers (LNNs), and/or other appropriate details. The orchestration device can then validate the changes made to the nodepool at time 728, and the success and/or failure of those changes can be reported by the orchestration device 52 back to the user device 50 at time 730.

With reference now to FIG. 8, the VM addition procedure 800 begins at time 802, at which the orchestration device 52 submits a PAPI call to the cloud computing cluster 54 to extend the backend Internet Protocol (IP) range of the cluster 54. Next, the VM addition procedure 800 enters a loop for each new VM to be created, in which metadata for the new VM is generated at time 810 and a PAPI call is provided to the cluster 54 to add the new VM at time 812.

Once the operations shown at times 810 and 812 are completed for each new VM, procedure 800 progresses to time 820, during which each new VM is created via the cloud provider API 56 along with volumes, virtual network interface cards (VNICs), and/or other components associated with the VMs. The new VMs are then merged into the cluster 54 via the loop shown at times 830 and 832, in which the orchestration device 52 submits a PAPI call to query the nodes in the cluster 54 at time 830 and the cluster 54 responds with the cluster status at time 832. The operations shown at times 830 and 832 can be repeated until all new VMs are merged into the cluster 54.

Once all VMs have been merged into the cluster, the orchestration device 52 can submit another PAPI call to the cluster 54 at time 840 to expand the default static network pool. Additionally, if a dynamic external network pool exists, the orchestration device 52 can also submit a PAPI call to the cloud provider API 56 at time 850 to expand the dynamic network pool.

Turning to FIG. 9, the volume addition procedure 900 can begin at time 902, in which the orchestration device 52 can create volumes for all nodes in the nodepool via the cloud provider API 56. Subsequently, the orchestration device 52 can submit PAPI calls to the cloud computing cluster 54 at time 910 to add the created volumes to the respective nodes in the nodepool.

With reference to FIG. 10, the procedure 1000 for completing the infrastructure upgrade can begin at time 1002, in which the orchestration device 52 can provide a PAPI call to the cluster 54 to mark the infrastructure upgrade as complete. The cluster can then initiate a data protection job at time 1004, which can complete at time 1006 to complete procedure 1000.

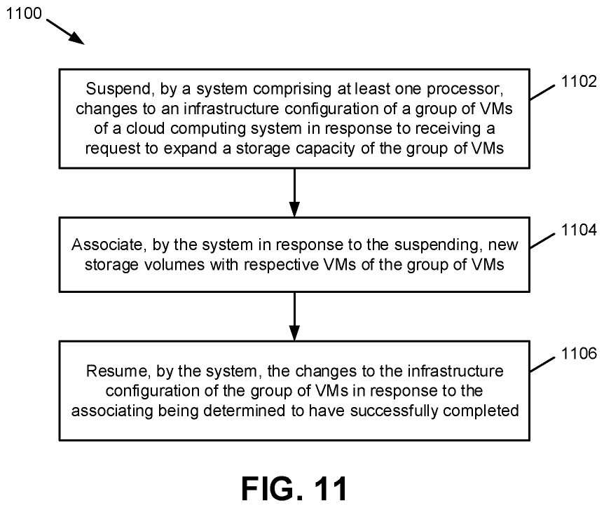

Turning to FIG. 11, a flow diagram of a method 1100 that facilitates storage capacity expansion using volume addition for cloud computing clusters is illustrated. At 1102, a system comprising a processor can suspend (e.g., by a configuration component 110) changes to an infrastructure configuration of a group of VMs (e.g., VMs 20, 22) of a cloud computing system (e.g., a system including a cloud computing cluster 10) in response to receiving a request to expand a storage capacity of the group of VMs.

At 1104, the system can associate (e.g., by a storage expansion component 120) new storage volumes (e.g., volumes 40, 42) with respective VMs of the group of VMs.

At 1106, the system can resume (e.g., by the configuration component 110) the changes to the infrastructure configuration of the group of VMs in response to the associating at 1104 being determined to have successfully completed.

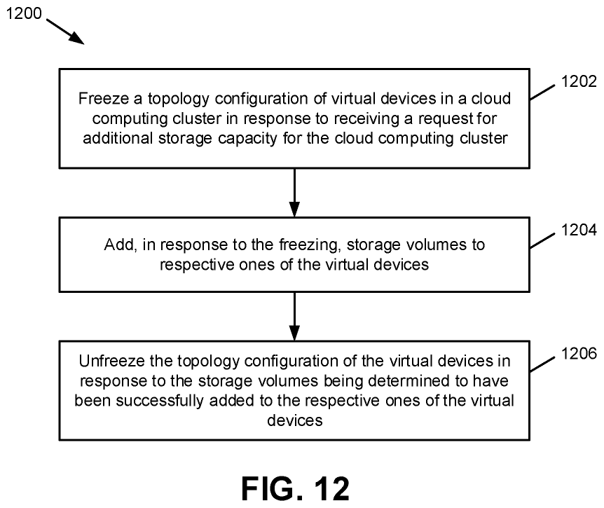

Referring next to FIG. 12, a flow diagram of a method 1200 that can be performed by a processor, e.g., based on machine-executable instructions stored on a non-transitory machine-readable medium, is illustrated. An example of a computer architecture, including a processor and non-transitory media, that can be utilized to implement method 1200 is described below with respect to FIG. 13.

Method 1200 can begin at 1202, in which the processor can freeze a topology configuration of virtual devices in a cloud computing cluster in response to receiving a request for additional storage capacity for the cloud computing cluster.

At 1204, the processor can add, in response to the freezing at 1002, storage volumes to respective ones of the virtual devices.

At 1206, the processor can unfreeze the topology configuration of the virtual devices in response to the storage volumes being determined to have been successfully added to the respective ones of the virtual devices at 1204.

FIGS. 11-12 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 13 and the following discussion are intended to provide a brief, general description of a suitable computing environment 1300 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 13, an example general-purpose environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD), a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a configuration component that freezes a topology configuration of a cluster of virtual machines (VMs) operating in a cloud computing system in response to a storage expansion request for the cluster of VMs; and
a storage expansion component that adds new storage volumes to respective VMs of the cluster of VMs in response to the configuration component freezing the topology configuration of the cluster of VMs, wherein the configuration component facilitates updating the topology configuration of the cluster of VMs in response to the storage expansion component successfully adding the new storage volumes.

2. The system of claim 1, wherein the new storage volumes are of a common capacity.

3. The system of claim 2, wherein respective storage volumes associated with the respective VMs prior to addition of the new storage volumes are of the common capacity.

4. The system of claim 3, wherein the executable components further comprise:
a volume quantization component that determines a first amount of the new storage volumes to be added by the storage expansion component as a function of a total amount of storage capacity specified in the storage expansion request, the common capacity, and a second amount of the respective VMs of the cluster of VMs.

5. The system of claim 1, wherein the storage expansion component adds an equal amount of the new storage volumes to each VM in the cluster of VMs.

6. The system of claim 1, wherein the executable components further comprise:
a request processing component that compares a first amount of storage capacity specified in the storage expansion request to a second amount of storage capacity managed by a VM of the cluster of VMs, wherein the storage expansion component adds the new storage volumes to the respective VMs of the cluster of VMs in response to the first amount of storage capacity being less than the second amount of storage capacity.

7. The system of claim 1, wherein the storage expansion component adds the new storage volumes to a subset of the cluster of VMs, the subset of the cluster of VMs comprising less than all of the cluster of VMs, and wherein respective VMs in the subset of the cluster of VMs share a common configuration.

8. The system of claim 1, wherein the executable components further comprise:
a volume provisioning component that assigns respective ones of the new storage volumes to respective volume failure domains associated with the cloud computing system in response to the configuration component facilitating the updating of the topology configuration of the cluster of VMs.

9. The system of claim 1, wherein the configuration component freezes the topology configuration of the cluster of VMs by submitting a request to an application programming interface (API) associated with the cluster of VMs.

10. A method, comprising:
suspending, by a system comprising at least one processor, changes to an infrastructure configuration of a group of virtual machines (VMs) of a cloud computing system in response to receiving a request to expand a storage capacity of the group of VMs;
associating, by the system in response to the suspending, new storage volumes with respective VMs of the group of VMs; and
resuming, by the system, the changes to the infrastructure configuration of the group of VMs in response to the associating being determined to have successfully completed.

11. The method of claim 10, wherein the new storage volumes are configured with a volume capacity, and wherein respective storage volumes associated with the group of VMs prior to the associating are configured with the volume capacity.

12. The method of claim 11, further comprising:
determining, by the system, a count of the new storage volumes based on a function of a total amount of additional storage capacity specified in the request, the volume capacity, and a number of VMs in the group of VMs.

13. The method of claim 10, wherein the associating comprises associating an equal amount of the new storage volumes with each VM in the group of VMs.

14. The method of claim 10, further comprising:
comparing, by the system, an amount of additional storage capacity, specified in the request, to an amount of managed storage capacity, managed by a VM of the group of VMs, wherein the associating is in response to the amount of additional storage capacity being less than the amount of managed storage capacity.

15. The method of claim 10, wherein the respective VMs of the group of VMs are a subgroup of the group of VMs that comprises less than all of the group of VMs, and wherein the respective VMs are placed into the subgroup of the group of VMs based on a common configuration characteristic shared by the respective VMs.

16. A non-transitory machine-readable medium comprising computer executable instructions that, when executed by a processor, facilitate performance of operations, the operations comprising:
freezing a topology configuration of virtual devices in a cloud computing cluster in response to receiving a request for additional storage capacity for the cloud computing cluster;
adding, in response to the freezing, storage volumes to respective ones of the virtual devices; and
unfreezing the topology configuration of the virtual devices in response to the storage volumes being determined to have been successfully added to the respective ones of the virtual devices.

17. The non-transitory machine-readable medium of claim 16, wherein the storage volumes are first storage volumes, wherein the first storage volumes have a common capacity, and wherein second storage volumes, associated with the virtual devices prior to the adding, have the common capacity.

18. The non-transitory machine-readable medium of claim 17, wherein the operations further comprise:
determining an amount of the storage volumes to be added based on a function of a first amount of the additional storage capacity provided in the request, the common capacity, and a second amount of the virtual devices in the cloud computing cluster.

19. The non-transitory machine-readable medium of claim 16, wherein the adding comprises adding an equal amount of the storage volumes to each of the virtual devices.

20. The non-transitory machine-readable medium of claim 16, wherein the operations further comprise:
comparing a first amount of the additional storage capacity provided in the request to a second amount of storage capacity managed by a virtual device of the virtual devices, wherein the adding is in response to the first amount being less than the second amount.
